(19) United States
(12) Patent Application Publication
(10) Pub. No.: US 2026/0233275 A1
(43) Pub. Date: Aug. 13, 2026

(54) TEMPERATURE CONTROL DEVICE AND METHOD FOR HEATING WORK ROLLS

(71) Applicant: Achenbach Buschhütten GmbH & Co. KG, Kreuztal (DE)

(72) Inventors: André BARTEN, Siegen (DE); Christian SCHNEIDER, Olpe (DE)

(21) Appl. No.: 19/155,391

(22) PCT Filed: Nov. 23, 2023
(86) PCT No.: PCT/EP2023/082869

§ 371 Date: Aug. 11, 2025

(30) Foreign Application Priority Data
Feb. 16, 2023 (DE) 10 2023 103 821.4
May 12, 2023 (DE) 10 2023 112 623.7

(51) Int. Cl. B21B 37/74; B21B 37/32; H05B 6/06; H05B 6/14

(52) U.S. Cl. CPC B21B 37/74; B21B 37/32; H05B 6/06; H05B 6/145

(57) ABSTRACT

A temperature control device and a method for inductively heating work rolls for rolling tape- or plate-shaped rolling stock, tapes, films, metal films, metal films made of aluminum or the like is disclosed. The temperature control device includes at least one temperature control unit having at least one induction coil which is assigned to a working roll. The induction coil is disposed in or on a casing of the temperature control unit, the temperature control device comprising a transformer, the transformer being designed to transform an input voltage into a lower output voltage of the transformer, to which the induction coil is connected, the transformer being disposed adjacent to the induction coil, the transformer being integrated directly in the casing or disposed directly on the casing.

The invention relates to a temperature control device and a method for inductively heating work rolls for rolling tape- or plate-shaped rolling stock, tapes, films, metal films, metal films made of aluminum or the like, the temperature control device comprising at least one temperature control unit having at least one induction coil, which is assigned to a work roll.

Such temperature control devices and methods are regularly used on roll stands for local heating of rolls and/or work rolls. A transverse profile of the roll and thus the rolling stock can be influenced by a radial expansion of the roll associated with the heating of the roll. It is known to determine in which area of a roll a roll-gap transverse profile should be influenced by means of local heating and the associated radial expansion of the roll by measuring a longitudinal tensile stress distribution in the rolling stock and/or by measuring a thickness distribution over a width of the rolling stock.

In addition to the use of induction coils, it is also known to apply heated cooling lubricant or roll oil to a roll, which expands radially as a result. The disadvantages here are sluggish heating of the roll, poor efficiency and a blurred delimitation of an effective area.

DE 2 743 130 A1 discloses a temperature control device made of a number of induction coils disposed along a roll on the roll. Since the induction coils are in a fixed position, it is only possible to heat the roll in the corresponding arrangement area of the induction coils. In addition, depending on the roll width, a correspondingly large number of induction coils is required in order to be able to heat the roll in the desired arrangement areas.

EP 1 222 973 overcomes this disadvantage in that two induction coils are disposed on a guide element so as to be movable in an axial direction along a roll. Here it is possible to move the respective induction coils to an area where the roll is to be heated. Any area of the roll can be controlled in temperature with just a few induction coils.

As the inductive heating of rolls requires comparatively high currents to generate a sufficiently strong magnetic field by means of an induction coil, cables extending between the induction coil and a power source must have a correspondingly large cross section in order to be able to ensure a permanent supply of the induction coil with a high current. However, cables with correspondingly large conductor cross sections are comparatively expensive and can only be laid with large bending radii, which results in a complex design and complex assembly of the temperature control device. In the case of induction coils which can be moved on a roll, the cables must be designed to be movable, which makes the temperature control device considerably more expensive.

The object of the invention at hand is therefore to propose a temperature control device and a method for inductively heating work rolls which both allow precisely and cost-effectively controlling the temperature of a work roll.

This object is attained by a temperature control device having the features of claim 1, a roll stand having the features of claim 17 and a method having the features of claim 19.

The temperature control device for inductively heating work rolls for rolling tape- or plate-shaped rolling stock, tapes, films, metal films, metal films made of aluminum or the like comprises at least one temperature control unit having at least one induction coil which is assigned to a working roll, the induction coil being disposed in or on a casing of the temperature control unit, the temperature control device comprising a transformer, the transformer being designed to transform an input voltage into a lower output voltage of the transformer, to which the induction coil is connected, the transformer being disposed adjacent to the induction coil, the transformer being integrated directly in the casing or disposed directly on the casing.

By using the transformer connected downstream of a power source of the temperature control device, an output voltage of the power source and/or the input voltage of the transformer can be transformed into the lower output voltage. Consequently, the transformer is also configured to transform an input current of the transformer into a higher output current to which the induction coil is connected. Since the transformer is adjacent to the induction coil, i.e., is located on a roll stand having the work roll, for example, cables extending from the power source to the transformer can be thinner, i.e., have a comparatively smaller cross section, due to the comparatively higher input voltage compared to the output voltage. This makes it significantly easier to lay the cables to the power source and the thinner cables are much cheaper to procure than comparatively thicker cables, which would otherwise have to be laid from the power source to the work roll.

The induction coil is disposed in or on a casing of the temperature control unit. The casing can, for example, be formed with a completely closed or partially open solid shell. The casing can also be formed by a body and/or physical object. In this case, the induction coil is disposed outside the casing or in the casing. The induction coil can thus also be encapsulated in the casing, for example in a plastic material or in another suitable material. In this case, it is advantageous if at least sections of the casing are made of a dielectric material, at least in sections. Accordingly, the casing can be made of different materials. It is essential that a magnetic field of the induction coil is not weakened or significantly influenced by the casing or casing parts in the area of the work roll.

Furthermore, the transformer is integrated directly in the casing or disposed directly on the casing. The transformer is therefore disposed outside of the casing, in a connection with the casing or inside the casing. The casing can then essentially completely surround the transformer so that the transformer is protected from adverse environmental influences. This also allows the transformer to be disposed at a short distance from the work roll. For example, the casing can be made of sheet steel or the like.

The transformer can be connected to the induction coil by means of rigid cables and/or to a power source by means of flexible cables. A cable connection between the transformer and the induction coil must be formed using comparatively thicker cables due to a lower output voltage and/or a higher output current. The cables can therefore be advantageously rigid in this case. A cable connection between the power source and the transformer is possible using comparatively thinner cables so that at least sections, but also the entirety of this cable connection can be formed using flexible cables. Since the flexible cables can be comparatively thinner, the costs for flexible cables are significantly reduced. In addition, the use of flexible cables also enables the temperature control device and/or the induction coil to be moved on the work roll.

The temperature control device can comprise another transformer, the other transformer being able to be designed to transform an input voltage into a higher output voltage of the other transformer, to which the transformer can be connected. The other transformer can then be connected between the power source and the transformer so that an output voltage of the power source can be converted into an even higher output voltage by means of the other transformer. This makes it possible to further reduce the cross section of cables that extend between the additional transformer and the transformer. The other transformer can be disposed adjacent to the power source so that thin cables can form the cable connection from the power source to the induction coil for the most part and/or over the longest possible distance of the cable connection. The transformer and the other transformer can be matched to each other with regard to the higher output voltage and the input voltage.

The temperature control unit can comprise the transformer. In the event that a plurality of temperature control units is provided, each temperature control unit can then have a transformer. In principle, however, it is also possible for a single transformer to be provided for a plurality of temperature control units.

The temperature control unit can comprise several induction coils. The temperature control unit can then be designed in such a manner that several induction coils can be disposed, for example next to each other on a circumference of a work roll. These induction coils can be supplied with power via a single transformer.

The casing can be made of a first casing part having the induction coil and a second casing part having the transformer, the first casing part and the second casing part being able to be connected to each other at a distance via a hollow profile. The first casing part having the induction coil can then be disposed close to the work roll, the second casing part having the transformer being able to be disposed at a distance from the work roll and/or the induction coil. The distance can be <3 m, preferably <2 m, particularly preferably <1 m. Furthermore, it can optionally be provided that the first casing part and the second casing part are connected to each other via a hollow profile, the hollow profile bridging the distance between the casing parts. The hollow profile is then also part of the housing. Inside the hollow profile, which can also be designed as a simple cover, cables, in particular rigid, straight cables having a large cross section for transmitting large currents, can extend from the first casing part having the induction coil to the second casing part having the transformer in a protected manner.

A magnetic field of the induction coil can be adapted to a circumference of the work roll. The induction coil can then be designed in such a manner that the magnetic field follows the circumference and/or a radius of the work roll, at least in sections.

Hence, a coil axis of the induction coil can be straight or have a radius adapted to a circumference of the work roll. A coil axis is understood here to be a winding axis and/or longitudinal axis of a helically wound induction coil. In principle, it is possible to design the induction coil with a straight coil axis. If the coil axis is adapted to a circumference of the work roll, in particular if it is formed in a radius which runs coaxially to a radius of the work roll, field lines of a magnetic field of the induction coil can extend at a uniform distance from a surface of the work roll, whereby heating of the work roll can be optimized.

A distance of the coil axis can be consistently the same in relation to the circumference of the work roll. Field lines of the magnetic field can then extend at a substantially uniform distance from a surface of the work roll, so that optimum heating of the relevant area of the work roll can be achieved.

The temperature control unit can be adapted in such a manner to a circumference of the work roll that an even gap can be formed between the temperature control unit and the work roll. Thus, a casing of the temperature control unit can be designed in such a manner that the casing fits snugly against the circumference of the work roll and the uniform gap is formed between the casing and the work roll. The induction coil can thus be disposed as close as possible to the work roll. It is possible for a coil axis of the induction coil to extend in the axial or radial direction of the work roll. In principle, it is then also possible to dispose several induction coils next to each other.

The temperature control device can comprise at least one guide element for at least one temperature control unit or several temperature control units, by means of which the temperature control unit can be positioned in an axial direction in relation to the work roll. The guide element can, for example, be formed by a linear guide on which the temperature control unit or several temperature control units can be displaced in the axial direction independently of one another. This displacement and/or positioning can take place by means of one or more motors, for example by means of an electric motor, spindle gear or the like, of the guide element. It is possible that the transformer can be positioned together with the induction coil, i.e., can be moved together. Furthermore, the guide element can also be designed in such a manner that the temperature control unit or several temperature control units can be positioned together or independently of each other in the radial direction in relation to the work roll. In this manner, a distance of the induction coil in relation to the work roll can be set or the induction coil can be removed from the work roll for a change.

The temperature control device can comprise another guide element for at least one temperature control unit or several temperature control units, by means of which the temperature control unit is positionable in a radial direction in relation to the work roll. Furthermore, the temperature control unit or several temperature control units can be pre-positioned in relation to the work roll in the radial direction by means of a guide element. The additional guide element can be used for fine positioning. Thus, the guide element can be used for fast and/or approximate positioning and the additional guide element for comparatively slower and/or precise positioning.

The temperature control device can comprise a frequency converter. The frequency converter can be used to change an output frequency and/or an output amplitude of a power source. The frequency converter can be supplied with single-phase AC voltage, three-phase AC voltage or DC voltage via the power source, so that in principle any type of voltage S and/or power source can be used for the temperature control device.

A translation ratio of the transformer can be between 1:2 and 1:1000 or more. In particular, the translation ratio of the transformer can be 1:2, 1:10, 1:100 or up to 1:1000 or more. The output voltage of the transformer can be changed in this ratio to the input voltage by means of the transformer.

The temperature control device can comprise a cooling device for cooling the temperature control unit. The cooling device can be operated with different cooling media, for example water, deionized water, cooling lubricant or oil.

The temperature control device can comprise a control element for controlling the temperature control device and/or for relatively positioning the temperature control unit and/or for controlling a temperature of the work roll and/or a roll gap. The control element can be formed by a computer or a programmable logic controller. The control element can be used to position the induction coil in relation to the work roll by means of a drive. Furthermore, an output voltage and/or an output current of the transformer can be regulated in such a manner by the control element that a desired temperature is obtained. The temperature of the work roll can in turn be regulated in such a manner by the control element that a desired roll gap is obtained as a result of thermal expansion in the work roll. A thickness of the rolling stock can be determined by measuring a belt tension or the like and be processed by the control element which, if necessary, can adjust the thickness as described above.

The roll stand according to the invention for rolling tape- or plate-shaped rolling stock, tapes, films, metal films, metal films made of aluminum or the like comprises at least one temperature control device according to the invention.

One or several temperature control units of the temperature control device can be disposed on one or several work rolls of the roll stand. Thus, all work rolls of the roll stand can be heated using temperature control units of the temperature control device, if necessary. This enables a very precise formation of a roll gap and thus a thickness of the rolling stock.

Further advantageous embodiments of the roll stand are derived from the descriptions of features of the dependent claims referring to device claim 1.

In the method for inductively heating work rolls for rolling tape- or plate-shaped rolling stock, tapes, films, metal films, metal films made of aluminum or the like, at least one induction coil of at least one temperature control unit of a temperature control device influences a temperature of a work roll and thus a radial expansion of the work roll, a transformer of the temperature control device, which is adjacent to the induction coil, transforming an input voltage to a lower output voltage of the transformer, to which the induction coil is connected. For the advantageous effects of the method, reference is made to the description of the advantages of the device according to the invention.

Further advantageous embodiments of the method are derived from the description of features of the dependent claims referring to device claim 1.

In the following, preferred embodiments of the invention are described in more detail with reference to the enclosed drawings.

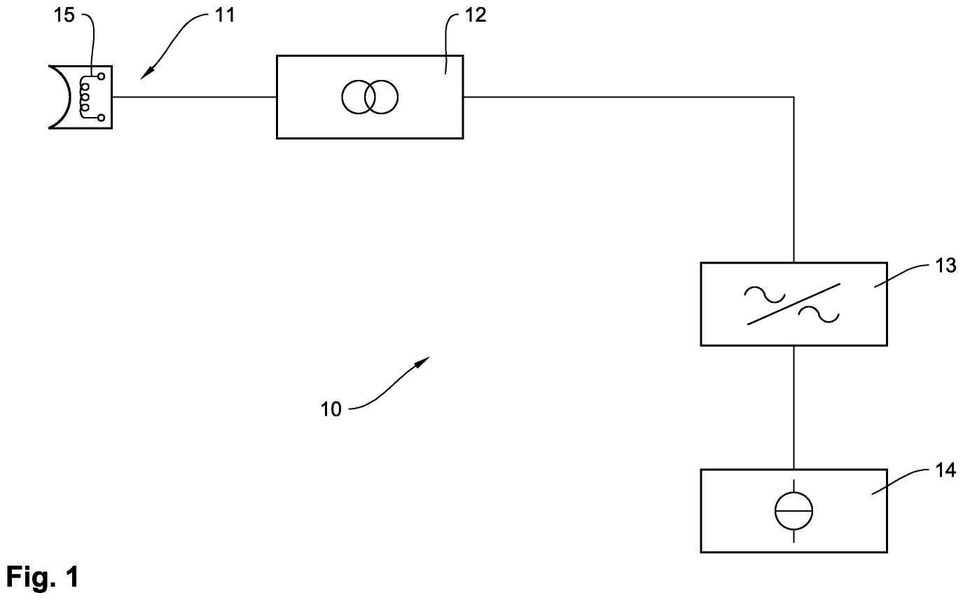

FIG. 1 shows a schematic view of a first embodiment of a temperature control device.

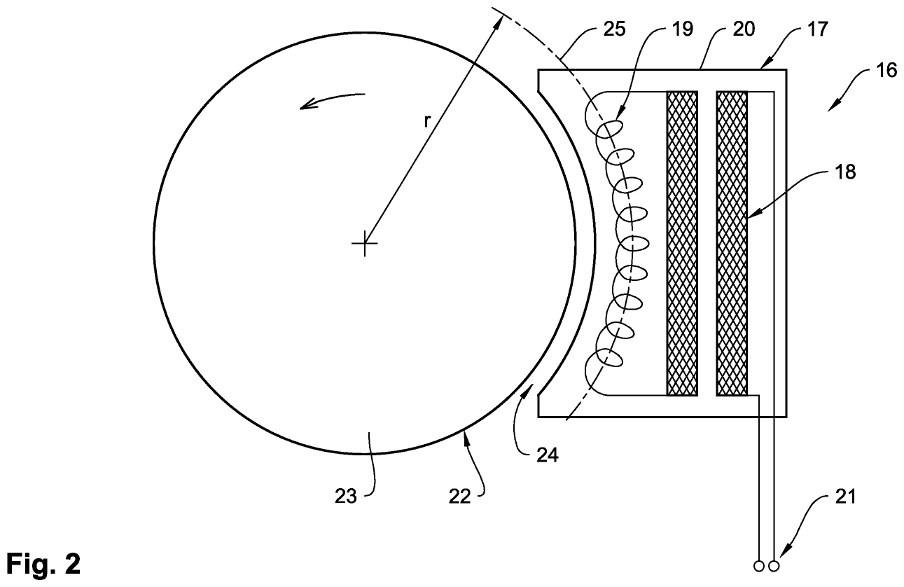

FIG. 2 shows a schematic view of a second embodiment of a temperature control device.

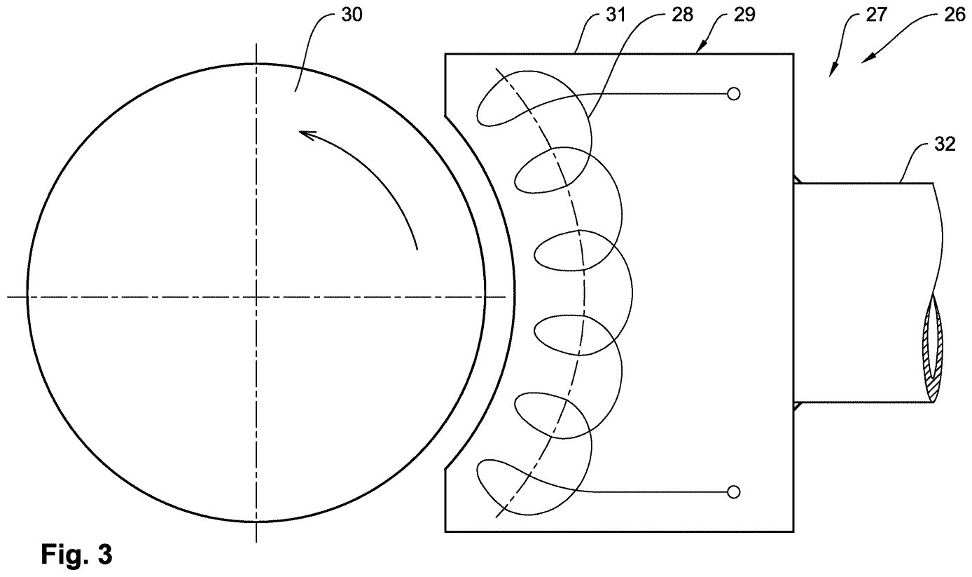

FIG. 3 shows a schematic view of a third embodiment of a temperature control device.

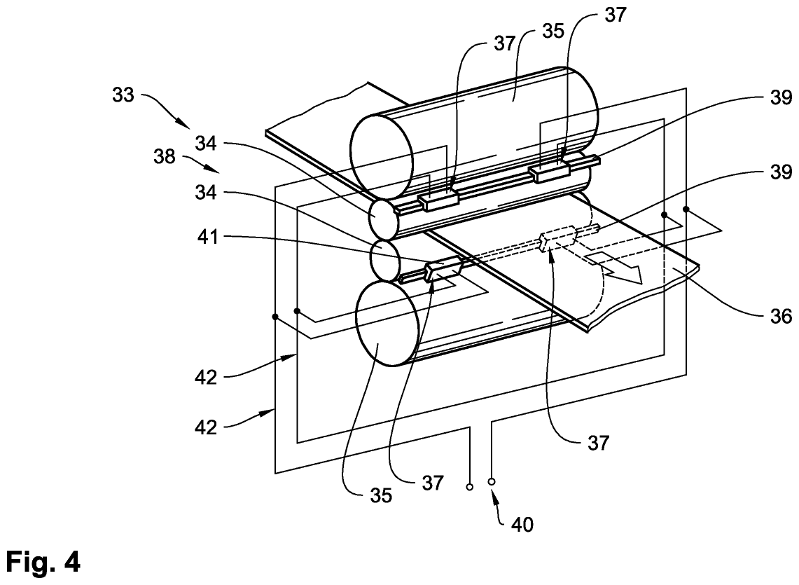

FIG. 4 shows a perspective partial view of a roll stand with a fourth embodiment of a temperature control device.

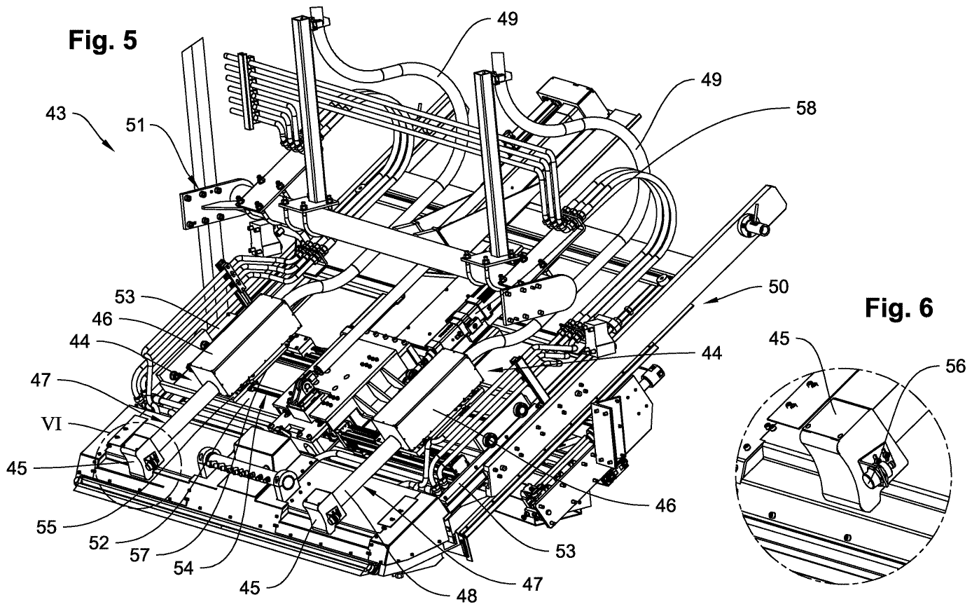

FIG. 5 shows a perspective partial view of a fifth embodiment of a temperature control device.

FIG. 6 shows a detailed view of FIG. 5.

FIG. 1 shows a first embodiment of a temperature control device 10 having a temperature control unit 11, a transformer 12, a frequency converter 13 and a power source 14, to which the temperature control device 10 is connected. The temperature control unit 11 has an induction coil 15, by means of which a work roll (not shown here) can be heated inductively. The temperature control device 10 is supplied with voltage via the power source 14, the frequency converter 13 adjusting a frequency and/or an amplitude of the voltage, and the downstream transformer 12 converting an input voltage from the frequency converter 13 into a lower output voltage. A correspondingly higher transformed output current can be used advantageously to heat the work roll by means of the induction coil 15.

FIG. 2 shows a temperature control device 16 formed from a temperature control unit 17 having a transformer 18 and an induction coil 19 inside a casing 20 of the temperature control unit 17. In particular, the transformer 18 is integrated directly into the casing 20 and connected to a power source 21. Here too, the transformer 18 is configured to transform an input voltage into a lower output voltage to which the induction coil 19 is connected. The casing 20 is adapted to a circumference 22 of a work roll 23 in such a manner that a uniform gap 24 is formed between the temperature control unit 17 and the work roll 23. Furthermore, a coil axis 25 of the induction coil 19 is formed with a radius r adapted to the circumference 22 of the work roll 23. Thus, the distance of the coil axis 25 in relation to the circumference 22 is always the same. This makes it possible to adapt a magnetic field (not shown here) of the induction coil 19 to the circumference 22 and thus to optimize heating the work roll 23 by means of the induction coil 19.

FIG. 3 shows a temperature control device 26 having a temperature control unit 27 and an induction coil 28 in a casing 29 on a work roll 30. In con-trast to the temperature control device in FIG. 2, a transformer (not shown here) is disposed at a distance from the induction coil 28. The casing 29 thus forms a first casing part 31 with the induction coil 28 and a second casing part (not shown here) with the transformer. The first casing part 31 is rigidly connected to the second casing part via a hollow profile 32. Comparatively thick cables (not shown here) which extend from the transformer to the induction coil 28, are routed through the hollow profile 32.

FIG. 4 shows a roll stand 33, however, only with work rolls 34 and support rolls 35 without a representation of roll stands in this instance. Strip-shaped material and/or rolling stock 36 is fed between the work rolls 34. Temperature control units 37 of a temperature control device 38 are disposed on each of the work rolls 34. The temperature control units 37 shown here schematically are disposed on guide elements 39 for each work roll 34, and can be positioned in relation to the work rolls 34 in an axial direction as required. Each of the temperature control units 37 is supplied with power via a common power source 40. In a respective casing 41 of the temperature control units 37, an induction coil (not shown here) and a transformer are disposed, by means of which an input voltage from the power source is transformed into a lower output voltage to which the induction coil is connected. This makes it possible to make cables 42 from the power source 40 to the respective temperature control units 37 comparatively thin and also flexible.

A combined view of FIGS. 5 and 6 shows a temperature control device 43, which is designed to be disposed on a work roll (not shown in detail here) of a roll stand. The temperature control device 43 comprises two temperature control units 44, each of which has an induction coil (not shown here) and a transformer. The induction coil is disposed in a first casing part 45 and the transformer in a second casing part 46 of a casing 47 of the temperature control unit 44. The first casing part 45 is connected to the second casing part 46 by means of a hollow profile 48. A flexible tube 49 is disposed on the second casing part 46 and leads to a power source (not shown here). Comparatively thin cables extending in the flexible tube 49 are flexible and connect the transformer to the power source. Comparatively thick and rigid cables extending in the hollow profile 48 connect the transformer to the induction coil. The transformer is configured so that an input voltage of the power source can be transformed into a lower output voltage of the transformer to which the induction coil is connected. This makes it possible to make the cables extending from the power source to the transformer thin and flexible.

Furthermore, the temperature control device 43 comprises a guide element 50, which is attached to a holding device 51. In particular, the guide element 50 is designed with a traverse 52 and lateral rails 53 such that the traverse 52 can be moved in a radial direction in relation to the work roll. This also makes it possible to set a distance between the temperature control units 44 and/or the respective induction coils and the work roll. Furthermore, the guide element 50 each have linear guides 54 on the traverse 52, which enable a respective table 55, on which the second casing part 46 is mounted, to be moved in the axial direction of the work roll. For the purpose of fine tuning the temperature control device 43, the traverse 52 has a further guide element 58 having a linear guide 57 with the table 55 in the manner of a cross table. This is used for fine positioning the temperature control device 43 in a radial direction in relation to the work roll. The guide element 50 can be moved in the desired manner by means of a control element (not shown here) of the temperature control device 43 and thus the temperature control units 44 can be pre-positioned in relation to the work roll. For fine positioning, a distance sensor 56 is disposed on the first casing part 45, a distance to the work roll being able to be determined and/or controlled by means of the distance sensor 56.

1. A temperature control device (10, 16, 26, 38, 43) for inductively heating work rolls for rolling tape- or plate-shaped rolling stock (36), tapes, films, metal films, or metal films made of aluminum, the temperature control device comprising at least one temperature control unit (11, 17, 27, 37, 44) having at least one induction coil (15, 19, 28) which is assigned to a working roll (23, 30, 34), wherein the induction coil is disposed in or on a casing (20, 29, 41, 47) of the temperature control unit, the temperature control device comprising a transformer (12, 18), the transformer being designed to transform an input voltage into a lower output voltage of the transformer, to which the induction coil is connected, the transformer being disposed adjacent to the induction coil, the transformer being integrated directly in the casing or disposed directly on the casing.

2. The temperature control device according to claim 1, wherein the transformer (12, 18) is connected to the induction coil (15, 19, 28) by means of rigid cables or to a power source (14, 21, 40) by means of flexible cables (42).

3. The temperature control device according to claim 1, wherein the temperature control device (10, 16, 26, 38, 43) comprises another transformer, the other transformer being designed to transform an input voltage into a higher output voltage of the other transformer, to which the transformer (12, 18) is connected.

4. The temperature control device according claim 1, wherein the temperature control unit (11, 17, 27, 37, 44) comprises the transformer (12, 18).

5. The temperature control device according to claim 1, wherein the temperature control unit (11, 17, 27, 37, comprises several induction coils (15, 19, 28).

6. The temperature control device according to claim 1, wherein the casing (20, 29, 41, 47) is made of a first casing part (31, 45) having the induction coil and a second casing part (46) having the transformer (12, 18), the first casing part and the second casing part being connected to each other at a distance via a hollow profile (32, 48).

7. The temperature control device according to claim 1, wherein a magnetic field of the induction coil (15, 19, 28) is adapted to a circumference (22) of the work roll (23, 30, 34).

8. The temperature control device according to claim 1, wherein a coil axis (25) of the induction coil (15, 19, 28) is straight or has a radius (r) adapted to a circumference (22) of the work roll (23, 30, 34).

9. The temperature control device according to claim 8, wherein a distance of the coil axis (25) is consistently the same in relation to the circumference (22).

10. The temperature control device according to claim 1, wherein the temperature control unit (11, 17, 27, 37, 44) is adapted in such a manner to a circumference (22) of the work roll (23, 30, 34) that an even gap (24) is formed between the temperature control unit and the work roll.

11. The temperature control device according to claim 1, wherein the temperature control device (10, 16, 26, 38, 43) comprises at least one guide element (39, 50) for at least one temperature control unit (11, 17, 27, 37, 44) or several temperature control units, by means of which the temperature control unit is positionable in an axial direction in relation to the work roll (23, 30, 34).

12. The temperature control device according to claim 1, wherein the temperature control device (10, 16, 26, 38, 43) comprises another guide element (58) for at least one temperature control unit (11, 17, 27, 37, 44) or several temperature control units, by means of which the temperature control unit is positionable in a radial direction in relation to the work roll (23, 30, 34).

13. The temperature control device according to claim 1, wherein the temperature control device (10, 16, 26, 38, 43) comprises a frequency converter (13).

14. The temperature control device according to claim 1, wherein a translation ratio of the transformer (12, 18) is between 1:2 and 1:1000 or more.

15. The temperature control device according to claim 1, wherein the temperature control device (10, 16, 26, 38, 43) comprises a cooling element for cooling the temperature control unit (11, 17, 27, 37, 44).

16. The temperature control device according to claim 1, wherein the temperature control device (10, 16, 26, 38, 43) comprises a control element for controlling the temperature control device or for relatively positioning the temperature control unit (11, 17, 27, 37, 44) or for controlling a temperature of the work roll (23, 30, 34) or a roll gap.

17. A roll stand (33) for rolling tape- or plate-shaped rolling stock (36), tapes, films, metal films, or metal films made of aluminum, the roll stand (33) having at least one temperature control device (10, 16, 26, 38, 43) according to claim 1.

18. The roll stand according to claim 17, wherein one or several temperature control units (11, 17, 27, 37, 44) of the temperature control device (10, 16, 26, 38, 43) are disposed on one or several work rolls (23, 30, 34) of the roll stand (33).

19. A method for inductively heating work rolls (23, 30, 34) for rolling tape- or plate-shaped rolling stock (36), tapes, films, metal films, or metal films made of aluminum, at least one induction coil (15, 19, 28) of at least one temperature control unit (11, 17, 27, 37, 44) of a temperature control device (10, 16, 26, 38, 43) influencing a temperature of a work roll (23, 30, 34) and thus a radial expansion of the work roll, wherein a transformer (12, 18) of the temperature control device, which is adjacent to the induction coil, transforms an input voltage to a lower output voltage of the transformer, to which the induction coil is connected.
